(19) United States
(12) Patent Application Publication
(10) Pub. No.: US 2003/0201629 A1
(43) Pub. Date: Oct. 30, 2003

(54) Method of inflating air bag

(76) Inventors: Naoki Matsuda, Hyogo (JP); Yoshihiro Nakashima, Hyogo (JP)

Correspondence Address: BIRCH STEWART KOLASCH & BIRCH, PO BOX 747, FALLS CHURCH, VA, 22040-0747, US

(21) Appl. No.: 10/132,259

(22) Filed: Apr. 26, 2002

(51) Int. Cl. B60R 21/26

(52) U.S. Cl. 280/736

(57) ABSTRACT

A method of inflating an air bag which can enhance an inflation durability of an air bag is provided.

The present invention is a method of inflating an air bag using an inflating gas from an inflator, and a method of inflating an air bag which discharges a sealing agent together with an inflating gas when an inflating gas is discharged into an air bag to inflate the air bag. Since the discharged sealing agent adheres to an inner surface of the air bag, the inflating gas is prevented from leaking from a seam portion of the air bag.

### TECHNICAL FIELD TO WHICH THE INVENTION BELONGS

The present invention relates to a method of inflating an air bag which can enhance an inflating performance of an air bag, and an inflator in which an inflating performance of an air bag is enhanced.

### PRIOR ART

As an inflator for an inflating type safety system of an automobile, in order to optimally protect a passenger in accordance with a position of a seat and the like in a vehicle such as a driver side, a passenger side, there are known various inflators such as an inflator for a driver side, an inflator for a passenger side next to the driver, an air bag inflator for a side collision, an inflator for a curtain air bag, an inflator for a knee-bolster air bag, an inflator for an inflatable seat belt, an inflator for a tubular system and an inflator for pretensioner.

Also, as these inflators, there are known one of types where only a pressurized medium comprising an inert gas such as argon, helium or the like is used as an inflating gas for an air bag, one of types where only a gas generated by combustion of a gas generating agent is used, and one of a type where both of the pressurized medium and a generated gas is used.

Among the above-described inflators, the inflator for a curtain air bag is one of types of inflating a curtain air bag with only the pressurized medium, and it instantaneously inflates and develops a curtain air bag having a thickness of several centimeters or so over a window of a vehicle, when the vehicle receives the impact from the lateral direction. Since the curtain air bag aims to protect a passenger from the impact from the lateral direction, and further the impact when a vehicle is turned over, it is necessary to shorten the time elapsed until the air bag inflates as compared with a case that the vehicle receives the impact from the front or the rear of the vehicle. Further, it is necessary to set an inflation duration to several seconds or so in view of a turning-over time.

Since the curtain air bag becomes long plate-shaped when it is inflated and developed, it is manufactured by sewing two or more sheets of materials and therefore it has a seam. In order to completely eliminate a possibility such that the pressurized medium leaks from gaps at the seam portion, a coating treatment on an inside of the air bag, particularly, the gaps at the seam portion is conducted by a coating agent. Also, there is also a possibility such that the pressurized medium leaks from gaps at woven portion of the cloth itself forming the air bag, and the possibility is eliminated by a coating treatment.

In the present status, the coating treatment may be simplified or abolished on a requirement of reducing a manufacturing cost. Meanwhile, if a substitute method which minimizes an increase in manufacturing cost and can exclude the possibility such that the pressurized medium leaks out is developed, such a method will have a high usability.

### DISCLOSURE OF THE INVENTION

An object of the present invention is to provide a method of inflating an air bag, which can enhance a durability at an inflation time of an air bag.

Other object of the present invention is to provide an inflator in which a durability of an air bag at a time of inflation is enhanced.

The present invention provides, as one means for solving the above-described problem, a method of inflating an air bag, which utilizes an inflating gas from an inflator to inflate an air bag, wherein, when the air bag is inflated by an inflating gas ejected into the in the air bag, a sealing agent is ejected together with the inflating gas.

The present invention provides, as other means for solving the above-described problem, an inflator comprising an inflator housing in which a pressurized medium for an air bag inflation is charged and an opening is formed at one end thereof, a diffuser portion which is fixed to the opening of the inflator housing and is provided with a gas discharging hole for discharging the pressurized medium flowing out from the opening at actuation, a rupturable plate closing a outflow path of the pressurized medium between the opening of the inflator housing and the diffuser portion, an igniter provided to the diffuser portion as a rupturing means of the rupturable plate, and a gas discharging port is connected to the gas discharging hole of the diffuser portion to be a discharging path of the pressurized medium, wherein a sealing agent is disposed inside or outside of the inflator.

Further, the present invention provides, still other means for solving the above-described problem, an inflator comprising an inflator housing, a gas generator which is accommodated in the inflator housing and is provided with a gas generating means, an igniting means chamber which is provided with an igniting means connected to the gas generator, and a pressurized medium including an inert gas charged in the inflator housing, wherein a sealing agent is disposed inside or outside of the inflator.

Furthermore, the present invention provides, as still other means for solving the above-described problem, an inflator comprising, in a housing having a gas discharging hole, an igniting means which includes an igniter to be actuated by an impact and a transfer charge, and a gas generating means which is ignited/burnt by the igniting means to generate a combustion gas for inflating an air bag, wherein a sealing agent is disposed outside of the inflator and in a state such that the sealing agent contacts the gas discharging hole of the housing.

By applying the method of inflating an air bag according to the present invention, the durability at an inflation time of an air bag can further be enhanced.

### BRIEF DESCRIPTION OF THE DRAWINGS

FIG. 1 is a sectional view in the longitudinal direction of an inflator for a curtain air bag;

FIG. 2 is a sectional view of a cartridge with a sealing agent charged, which is mounted to the inflator for a curtain air bag shown in FIG. 1; and

FIG. 3 is a vertical sectional view of a pyrotechnic inflator.

### EXPLANATION OF REFERENCE NUMERALS

10 inflator for a curtain air bag

12 inflator housing

14 opening

19 rupturable plate

20 diffuser portion

22 gas discharging hole

26 igniter

40 gas discharging port

42 communication hole

48 filter

50, 70 sealing agent cartridge

101 diffuser shell

102 closure shell

103 housing

104 igniter

106 gas generating agent

107 coolant

111 gas discharging hole (opening)

128 combustion chamber

### EMBODIMENT OF THE INVENTION

In a method of inflating an air bag of the present invention, when an air bag is inflated by an inflating gas discharged from an inflator into the air bag, a sealing agent is discharged together with the inflating gas.

As the inflating gas, a pressurized medium, a combustion gas of a gas generating agent or both of the pressurized medium and the combustion gas is used. The pressurized gas is not limited particularly, and an inert gas such as argon, helium, neon or the like, a nitrogen gas, an oxygen gas or the like can be used. The gas generating agent is not limited to specific materials as long as it can be used in an inflator for an air bag. Materials including various additives such as a binder, a slag-forming agent, a lubricating agent or the like can be used as the gas generating agent as well as a fuel such as a nitrogen containing compound or the like, and an oxidizing agent.

In view of discharging the sealing agent easily, it is preferable that the sealing agent is disposed in a flow path of an inflating gas inside an inflator, and when the inflating gas includes a pressurized medium, the sealing agent can be disposed in a space identical to or different from the space storing the pressurized medium inside the inflator.

The sealing agent can be disposed outside of the inflator. In this case, it is preferable that the sealing agent is disposed outside of the inflator and in a state such that it contacts a gas discharge hole of the inflator.

The sealing agent can be disposed in a state such that it is charged in a container which is attachable/detachable. In this case, it is desirable that the sealing agent is disposed outside of the inflator, in particular, in a state such that it contacts the gas discharging hole of the inflator. This attachable/detachable container has such a structure that it holds the sealing agent and can discharge the sealing agent accompanied with discharge of the inflating gas, and it is attachably/detachably mounted to the inflator by a proper method such as a screw, a press-fitting, a welding, an externally fastening means or the like.

The sealing agent can be one which is discharged together with an inflating gas and attaches to the inside of the air bag to exhibit a sealing performance. When the sealing agent is discharged together with an inflating gas, a powder or granular agent, and a liquid type agent such as an aqueous solution or an emulsion can be used. Incidentally, if the state of the sealing agent at a time of being discharged is a powdery or granular state, or an aqueous or emulsion state, the sealing agent may be a molded article formed in a desirable shape, or a gel shape.

It is preferable that the sealing agent has a boiling point higher than a temperature when the inflating gas is discharged, in order to prevent evaporation of the sealing agent by heat and to secure the sealing performance. Also, it is preferable that the sealing agent includes adhesive component in order to adhere to the inside of the air bag and to exhibit a sealing performance after discharged.

In the present invention, for example, one or at least two of members selected from the group consisting of thermoplastic adhesives such as polyvinyl acetate, polyvinyl alcohol, polyvinyl formal, polyvinyl butyral, acrylic resin, polyethylene, chlorinated polyethylene, ethylene-vinyl acetate copolymer, ethylene-vinyl alcohol copolymer, ethylene-ethyl acrylate copolymer, ethylene acrylic acid copolymer, ionomer, chlorinated polypropylene, polystyrene, plastisol, vinyl chloride-vinyl acetate copolymer, vinyl chloride-vinyl acetate-maleic anhydride copolymer, polyvinyl ether, polyvinyl pyrrolidone, polyamide, nylon, saturated amorphous polyester, cellulose derivatives and the like, and natural material base adhesives such as starch, dextrin, gum arabic, protein, glue, gelatin and the like are prepared in a desired aspect such as powder or granule, aqueous solution or emulsion or the like, so that they can be used as the sealing agent.

The method of inflating an air bag according to the present invention can close gaps existing in a sew portions of an air bag or gaps in a woven portion of a cloth itself which forms the air bag by discharging the sealing agent together with an inflating gas to cause the sealing agent to adhere to the inside of the air bag when the air bag is inflated. And, as a result, the inflating gas is prevented from leaking out so that an inflating pressure and an inflation duration time as designed can be secured.

The method of inflating an air bag according to the present invention can be applied to any type of an inflator inflating an air bag with only a pressurized medium, inflating an air bag by means of both of a pressurized medium and a combustion gas of a gas generating agent, or inflating an air bag with only a combustion gas of a gas generating agent. Incidentally, the method of inflating an air bag of the present invention is not applied to an air bag system having vent holes for allowing a gas to come out after inflation, such as an air bag for a driver seat or a passenger seat, but it is particularly suitable for an air bag which requires an inflation duration time for at least one second or more, for example, an inflator for a curtain air bag which inflates an air bag with only a pressurized medium.

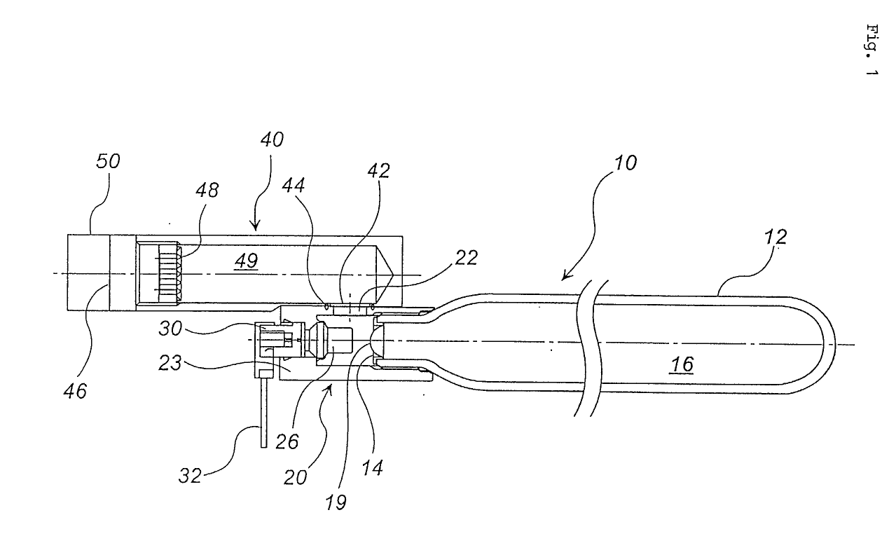

Next, an inflator for a curtain air bag of the present invention will be explained with reference to the drawings. FIG. 1 is a schematic sectional view in the longitudinal direction of an inflator for a curtain air bag.

An inflator housing 12 has an opening 14 at one end thereof and it is closed at the other end. A pressurized medium comprising an inert gas such as argon, helium or the like or a nitrogen gas is charged at the maximum pressure of about 70,000 kPa. The inflator housing 12 has a circular shape in the lateral direction, and the opening 14 is also circular.

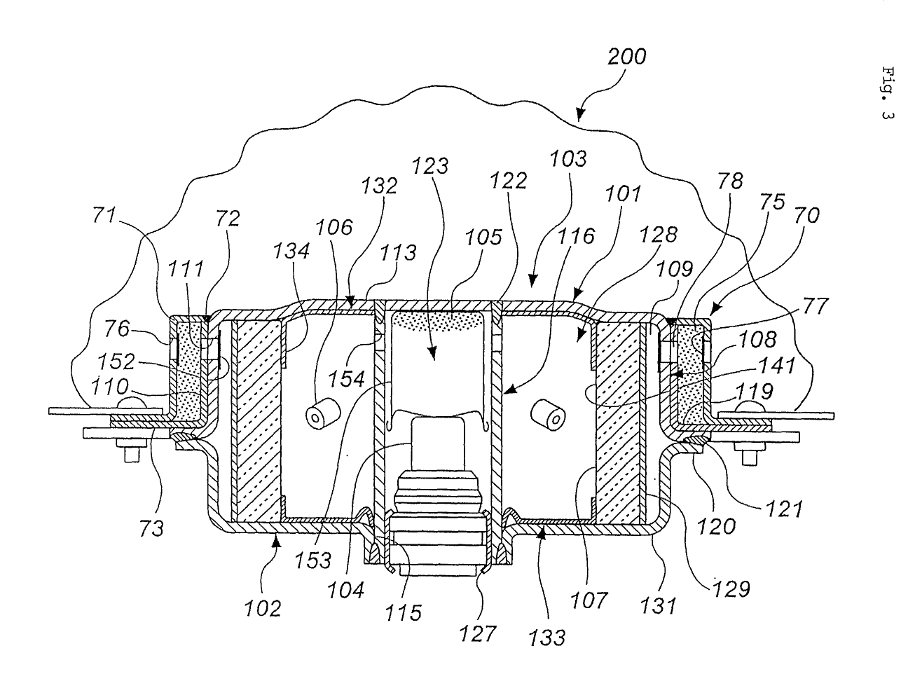

The inflator housing 12 may be formed by using an existing gas cylinder, and it may be manufactured by swaging a pipe. An inflator 10 shown in FIG. 1 is charged with a pressurized medium through the opening 14 of the inflator housing 12. An inflator 10 shown in FIG. 3 is charged with a pressurized medium via a clearance at a seal pin 13 inserted into a thin hole after a diffuser portion 20 is connected to the inflator housing 12 and then inflator 12 is welded at a portion of the seal pin 13 to be closed completely.

The diffuser portion 20 is connected to the opening 14 of the inflator housing 12. An outer shell of the diffuser portion 20 is formed by a diffuser housing 23 and a gas discharging hole 22 for discharging the pressurized medium outside is provided on the peripheral surface of the outer shell.

The inflator housing 12 and the diffuser portion 20 may be connected by a welding or they may be connected by providing a male screw portion on an outer peripheral surface of an end portion of the inflator housing 12, providing a female screw portion on an inner peripheral surface of an end portion of the diffuser portion 20 and screwing the male screw portion and the female screw portion.

The opening 14 of the inflator housing 12 is closed with a bowl-like rupturable plate 19, and an inner space 16 of the inflator housing 12 is maintained at a high pressure air tight state before actuation. And, the gas discharging hole 22 of the diffuser portion 20 is not closed.

An igniter 26 having a priming is provided in the diffuser portion 20 as a rupturing means for the rupturable plate 19. The igniter 26 is fitted into the diffuser housing 23 to be mounted to the diffuser portion 20. Numeral 30 denotes a connector and numeral 32 denotes a lead wire for connecting to a power supply.

A gas discharging port 40 is connected to the diffuser portion 20, and both the members are connected at a welding portion 44 by welding after the gas discharging hole 22 of the diffuser portion 20 meet a communication hole 42 of the gas discharging port 40.

The gas discharging port 40 is mounted such that the central axis (a one dotted chain line in FIG. 1) of the inflator housing 12 and the central axis (a one dotted chain line in FIG. 1) of the gas discharging port 40 becomes parallel to each other.

The gas discharging port 40 comprises a cylindrical member having one end closed and the other end formed with an opening 46, and a filter 48 for removing foreign matters is provided in the vicinity of the opening 46. A example of the filter 48 can be a wire mesh or a laminated body of wire mesh. A place where the filter 48 is arranged is not limited to a specific place as far as foreign matters can be removed from the discharged pressurized medium. For example, the filter 48 can be provided to cover a portion extending from a passage 49 of the pressurized medium to the communication hole 42.

An attachable/detachable cartridge 50 in which a sealing agent is charged is mounted to the opening 46 which serves as a gas discharging hole of the gas discharging port 40, and an air bag is connected to the cartridge 50. The cartridge 50 holds a sealing agent and it can discharge the sealing agent together with the pressurized medium without blocking discharging of the pressurized medium when the pressurized medium used for an inflating gas is discharged from the opening 46.

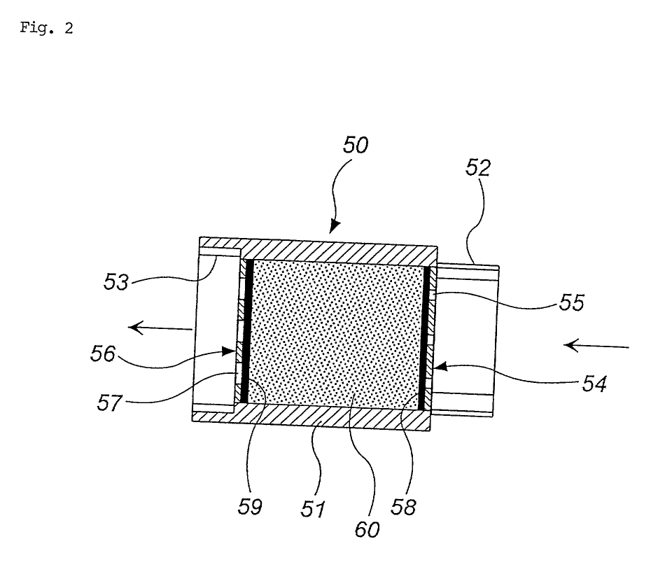

As the cartridge 50, for example, one having a sectional configuration shown in FIG. 2 can be used.

The cartridge 50 comprises a case 51 serving as an outer shell container, a male screw portion 52 provided at one end of the case 51, a female screw portion 53 provided at the other end thereof, and the male screw portion 52 has a hollow structure and is in communication with an inside of the case 51. A required amount of sealing agent 60 is charged in the case 51, and the male screw portion 52 side is closed by a porous partition plate 54 having one or two or more holes 55 and a sealing tape 58 (for example, an aluminum tape, a plastic tape, or a paper) adhered to close the holes 57 from the inside, while the female screw portion 53 side is closed by a porous partition plate 56 having one or two or more holes 57 and a sealing tape 59 (for example, an aluminum tape, a plastic tape, or a paper) adhered to close the holes 57 from the inside, so that the sealing agent 60 is prevented from leaking out. For discharging the sealing agent 60 together with the pressurized medium, it is desirable that the hole 57 of the porous partition plate 56 has a diameter larger than the hole 55 of the porous partition plate 54.

Since the cartridge 50 is mounted to the opening 46 of the gas discharging port 40 at the male screw portion 52 and the air bag is mounted at the female portion 53, the male screw portion 53 serves as a gas discharging hole virtually.

Incidentally, in the inflator for an curtain air bag shown in FIG. 1, besides a case of using the cartridge 50, a sealing agent may be charged in either of the inside of an inner space 16, the inside of the diffuser portion 20, and the inside of the gas discharging port 40 directly or in a state of being charged in a cartridge or the like.

Next, an operation of the inflator 10 for a curtain air bag of the present invention will be explained. When the inflator is mounted to a vehicle, the inflator 10 is equipped in a vehicle as a system in which an actuation signal-outputting means comprising an impact sensor and a control unit, a module case accommodating the above-described inflator 10 and a curtain air bag, and the like are combined. The curtain air bag is connected at the cartridge 50 mounted to the opening 46 of the gas discharging port 40.

First of all, when a vehicle receives the impact, the igniter 26 is activated upon receiving the signal from the impact sensor in the system and the rupturable plate 19 is ruptured by ignition/burning of the priming. Since the opening 14 is opened by the rupture of the rupturable plate 19, the pressurized medium in the inner space 16 flows out from the gas discharging hole 22 to flow in the gas discharging port 40 via the communication hole 42, and it further passes through the opening 46 and the cartridge 50 via the filter 48 to be discharged (an arrow shown in FIG. 2 indicates a discharging direction), thereby inflating the curtain air bag.

When the pressurized medium passes through the cartridge 50 in this manner, the pressurized medium passes through the hollow portion of the male screw portion 52 from the opening 46, ruptures the seal tape 58 from the holes 55 of the porous partition plate 54 to flow into the case 51, and then, ruptures the seal tape 58 to be discharged from the holes 57 of the porous partition plate 56 together with the sealing agent 60. The sealing agent thus discharged scatters in the inner side of the curtain air bag together with the pressurized medium to adhere to an inner surface of the curtain air bag. As a result, the seam portion of the air bag is in a state of being coated with the sealing agent, and therefore, the inflation time as designed can securely be maintained.

Incidentally, when the inflator for a curtain air bag of the present invention is applied as the inflator for a side collision, the gas discharging port 40 is unnecessary, and the air bag is connected at the cartridge 50 mounted to a portion of the gas discharging hole 22 directly or via a suitable adapter.

Also, even in a hybrid inflator in which an air bag is inflated using a pressurized medium and a combustion gas of a gas generating agent, a sealing agent can be disposed. The hybrid inflator comprises an inflator housing, a gas generator which is accommodated in the inflator housing and is provided with a gas generating means, and an igniting means chamber which is provided with an igniting means connected to the gas generator, a pressurized medium including an inert gas is charged in the inflator housing, and structures of the hybrid inflator other than these structures may be modified appropriately as long as the function thereof is not deteriorated.

In the hybrid inflator, the sealing agent can be disposed in a space identical to or different from the space where the pressurized medium is charged. The sealing agent can be disposed externally, particularly, in a state of contacting the gas discharging hole. In this case, the cartridge having the structure shown in FIG. 2 can be used.

Next, a pyrotechnic inflator in which an air bag is inflated by only a combustion gas of a gas generating agent will be explained with reference to FIG. 3. FIG. 3 is a vertical cross sectional view of a pyrotechnic inflator.

A pyrotechnic inflator includes a housing 103 which comprises a diffuser shell 101 and a closure shell 102, a central cylindrical member 116 disposed inside the housing 103, an igniting means (an igniter 104 and a transfer charge 105) disposed in a hollow portion inside the central cylindrical member 116, a gas generating means (a solid gas generating agent 106) to be ignited by the above means to generate a combustion gas, a coolant member (a coolant/filter 107) disposed to surround the gas generating agent 106, coolant supporting members (a plate member 132 and 133) disposed at both end portions of the coolant/filter 107, and an outer layer 129 comprising a laminated wire mesh body and arranged on an outer peripheral surface in a fitting manner in order to prevent a deformation of the coolant.

The diffuser shell 101 is constituted by pressing of a stainless steel plate, and one hundred and eighteen openings (gas discharging hole 111) corresponding to a circle with a diameter of 3 mm are formed in one line at equal intervals circumferentially in the circumferential wall portion 110 thereof. The maximum internal pressure of the housing is controlled by the openings 111. The closure shell 102 is also constituted by pressing a stainless steel plate, and a central hole 115 is formed in a bottom surface central portion thereof. The central cylindrical member 116 is disposed in the central hole 115.

The diffuser shell 101 and the closure shell 102 have flange portions 119 and 120, respectively, and the housing 103 is formed by joining the flange portions 119 and 120 by a laser welding 121. The inner volume of the housing is 120 ml, and the total area of the gas discharging holes is 1.13 cm².

The central cylindrical member 116 is integrated with the housing therein by an electron beam welding 122. The central cylindrical member 116 comprises a stainless steel pipe which has a thickness of 1.2 to 3.0 mm, preferably, 1.2 to 2.0 mm, and an outer diameter of 17 to 22 mm, preferably 17 to 20 mm, and whose both ends are open. Six through holes 154 having a diameter of 2.5 mm are formed at equal intervals in the peripheral wall.

The inside of the central cylindrical member 116 is an igniting means accommodating chamber, and an igniting means, an igniter 104 to be actuated by a signal from a sensor (not shown), and a transfer charge container 123 which is filled with a transfer charge 105 to be ignited by the igniter 104 are accommodated in the igniting means accommodating chamber 123. The igniter 104 is fixed by crimping a retaining means 127 for an igniter of the central cylindrical member 116. A space outside the central cylindrical member 116 serves as a combustion chamber 128, and many solid gas generating agents 106 having a hollow cylindrical body are disposed in the combustion chamber 128. Since the gas generating agent 106 is the hollow cylindrical body, even when combustion proceeds, the total surface area of the gas generating agent does not so change.

The coolant/filter 107 is disposed to surround the gas generating agents 106, and it defines an annular chamber, i.e., the combustion chamber 128 around the central cylindrical member 116. Since the coolant/filter 107 is formed by radially laminating plain-stitched wire mesh nets made of stainless steel to compress them in a radial direction and in an axial direction, its void structure becomes complicated, and it has an excellent arresting effect. Further, an outer layer 129 comprising a laminated wire mesh body is formed outside the coolant/filter 107, and it suppresses occurrence of an event such that the coolant/filter 107 bulges due to a gas pressure and a clearance 109 is blocked.

A plate member 132 and a plate member 133 are disposed at an upper end portion of the coolant/filter 107 and at a lower end portion thereof, respectively, thereby blocking movement of the coolant/filter 107. The plate member 132 at the upper end portion has a peripheral wall portion 134, and the peripheral wall portion 134 is disposed oppositely to the through holes 154 for a flame of the igniting means to cover an inner peripheral surface 141 of the coolant/filter which is positioned in the vicinity of the through holes 154.

A clearance 109 is formed between the outer peripheral wall 108 of the housing and the outer layer 129 disposed outside the coolant/filter 107, and a gas passage with an annular section in the axial direction is formed around the coolant/filter 107 by the clearance 109. In the pyrotechnic inflator shown in FIG. 3, in order to prevent moisture from invading in the housing 103 from the outside, the gas discharging holes 111 are closed by an aluminum tape 152.

A cartridge 70 is mounted to an outer peripheral surface of the diffuser shell 101 to enclose the gas discharging holes 111 from the surroundings thereof. The cartridge 70 is constituted by charging an inside of a cylindrical case 71 with a required amount of sealing agent 75. The case 71 is welded to the diffuser shell 101 at a portion 72 in FIG. 3, and it is screwed at portions of the flange portion 73, as shown. Through holes 78 are provided in an inner wall (part of a wall surface which contacts an outer peripheral surface of the diffuser shell 101) of the case 71, and they are in communication with the gas discharging holes 111. Through holes 76 closed by a seal tape 77 are provided in an outer wall of the case 71, and these through holes 76 actually serve as the gas discharging holes. An air bag 200 is screwed together with the flange portion of the inflator and the flange portion 73 of the cartridge 70. Incidentally, in the inflator shown in FIG. 3, the sealing agent can be disposed in the clearance 109 directly or using a cartridge or the like.

In the pyrotechnic inflator thus constituted, when a sensor (not shown) detects the impact, the signal is sent to actuate the igniter 104 so that the transfer charge 105 in the transfer charge container 153 ignites to generate a flame with a high temperature. The flame is discharged from the through holes 154 to ignite the gas generating agents 106 in the vicinity of the through holes 154 and the direction of the flame is bent by a circumferential wall portion to ignite the gas generating agents in a lower portion of the combustion chamber. Thereby, the gas generating agents are burnt to generate a gas with a high temperature and a high pressure. The generated gas passes through the entire coolant/filter 107. While passing, the gas is cooled effectively and the combustion residue is collected. The cooled and purified combustion gas passes through the gas passage (the clearance 109) to rupture the aluminum tape 152 to be discharged from the gas discharging holes 111 and flow into the cartridge 70. Thereafter, the combustion gas and the sealing agent 75 are discharged into the air bag 200.

1. A method of inflating an air bag using an inflating gas from an inflator, wherein a sealing agent is discharged together with an inflating gas when an air bag is inflated by the inflating gas discharged into an air bag.

2. A method of inflating an air bag according to claim 1, wherein the inflating gas is a pressurized medium, a combustion gas of a gas generating agent or a combination of them.

3. A method of inflating an air bag according to claim 1 or 2, wherein the sealing agent is disposed in a flow path of an inflating gas inside the inflator.

4. A method of inflating an air bag according to any one of claims 1 to 3, wherein the sealing agent is disposed in a space identical to or different from a space where the pressurized medium is charged when the inflating gas includes a pressurized medium.

5. A method of inflating an air bag according to any one of claims 1 to 3, wherein the sealing agent is disposed outside the inflator.

6. A method of inflating an air bag according to any one of claims 1 to 3, wherein the sealing agent is disposed outside the inflator and in a state of contacting a gas discharging hole of the inflator.

7. A method of inflating an air bag according to any one of claims 1 to 6, wherein the sealing agent is disposed in a state of being charged in an attachable/detachable container.

8. A method of inflating an air bag according to any one of claims 1 to 7, wherein the sealing agent is powdery or granular material when the sealing agent is discharged into the air bag together with the inflating gas.

9. A method of inflating an air bag according to any one of claims 1 to 7, wherein the sealing agent is liquid when the sealing agent is discharged into the air bag together with the inflating gas.

10. A method of inflating an air bag according to any one of claims 1 to 9, wherein the sealing agent has a boiling point higher than a temperature when the inflating gas is discharged into the air bag from the inflator.

11. A method of inflating an air bag according to any one of claims 1 to 10, wherein the sealing agent includes an adhesive component.

12. A method of inflating an air bag according to any one of claims 9 to 11, wherein the sealing agent is an emulsion.

13. A method of inflating an air bag according to any one of claims 1 to 12, wherein the inflator inflates an air bag with only a pressurized medium.

14. A method of inflating an air bag according to any one of claims 1 to 12, wherein the inflator inflates an air bag, using both a pressurized medium and a combustion gas of a gas generating agent.

15. A method of inflating an air bag according to any one of claims 1 to 12, wherein the inflator inflates an air bag with only a combustion gas of a gas generating agent.

16. An inflator comprising an inflator housing in which a pressurized medium for inflating an air bag is charged and an opening is formed at one end thereof, a diffuser portion which is fixed to the opening side of the inflator housing and is provided with a gas discharging hole for discharging the pressurized medium from the opening to the outside at actuation, a rupturable plate closing an outflow path for the pressurized medium between the opening of the inflator housing and the diffuser portion, an igniter provided at the diffuser portion to serve as a rupturing means for the rupturable plate, and a gas discharging port connected to the gas discharging port of the diffuser portion to serve as a discharging passage for the pressurized medium, wherein a sealing agent is disposed inside or outside of the inflator.

17. An inflator according to claim 16, wherein the sealing agent is disposed in a space identical to or different from a space charged with the pressurized medium in the inflator.

18. An inflator comprising an inflator housing, a gas generator which is accommodated in the inflator housing and is provided with a gas generating means, an igniting means chamber provided with an igniting means connected to the gas generator, and a pressurized medium including an inert gas charged in the inflator housing, wherein a sealing agent is disposed inside or outside of the inflator.

19. An inflator according to claim 18, wherein the sealing agent is disposed in a space identical to or different from a space charged with the pressurized medium in the inflator.

20. An inflator comprising, in a housing having a gas discharging hole, an igniting means including an igniter to be actuated by the impact and a transfer charge, and a gas generating means which is to be ignited/burnt by the igniting means to generate a combustion gas for inflating an air bag, wherein a sealing agent is disposed outside the inflator and in a state of contacting the gas discharging hole of the housing.

21. An inflator according to any one of claims 16, 18 and 20, wherein the sealing agent is disposed outside the inflator in a state of contacting the gas discharging hole of the housing.

22. An inflator according to any one of claims 16 to 21, wherein the sealing agent is disposed in a state of being charged in an attachable/detachable container.

23. An inflator according to any one of claims 16 to 22, wherein the sealing agent is a powdery or a granular material when the sealing agent is discharged into the air bag together with an inflating gas for an air bag.

24. An inflator according to any one of claims 16 to 22, wherein the sealing agent is liquid when the sealing agent is discharged into the air bag together with an inflating gas for air bag.

25. An inflator according to any one of claims 17 to 25, wherein the sealing agent has a boiling point higher than a temperature when the inflating gas is discharged.

26. An inflator according to any one of claims 16 to 25, wherein the sealing agent includes an adhesive component.

27. An inflator according to any one of claims 24 to 26, wherein the sealing agent is an emulsion.
